(19) United States
(12) Patent Application Publication
(10) Pub. No.: US 2015/0246318 A1
(43) Pub. Date: Sep. 3, 2015

(54) Methods to Rapidly Deposit Thin Films (or Coatings) of Microporous Material on Supports Using Thermally Induced Self-Assembly

(71) Applicant: THE TEXAS A&M UNIVERSITY SYSTEM, College Station, TX (US)

(72) Inventors: Hae-Kwon Jeong, College Station, TX (US); Miral N Shah, College Station, TX (US); Hyuk Taek Kwon, College Station, TX (US)

(73) Assignee: The Texas A&M University System, College Station, TX (US)

(21) Appl. No.: 14/435,696

(22) PCT Filed: Oct. 22, 2013
(86) PCT No.: PCT/US2013/066221

§ 371 Date: Apr. 14, 2015

Related U.S. Application Data
(60) Provisional application No. 61/717,039, filed on Oct. 22, 2012.

(51) Int. Cl. B01D 67/00; B05D 1/18; B05D 3/10; B05D 3/06

(52) U.S. Cl. CPC B01D 67/0083; B05D 3/06; B05D 1/18; B05D 3/107; B01D 2323/34

(57) ABSTRACT

A method produces metal-organic framework. In one embodiment a method for producing a metal-organic framework comprises contacting a porous support with a solution comprising a metal and a solvent, contacting a porous support with a solution comprising a ligand and a second solvent, and heating the support for a period of time suitable to substantially evaporate the solution and produce crystals on the surface and the pores.

### BACKGROUND OF THE INVENTION

This invention relates to the field of gas separation and more specifically to the construction of metal-organic framework (MOF), for example zeolitic-imidazolate frameworks (ZIF), for use as gas separation membranes prepared by methods of depositing materials on substrates using rapid thermal deposition or counter diffusion.

Metal-organic frameworks such as zeolitic-imidazolate frameworks, are a class of organic-inorganic hybrid materials. The metal-organic frameworks are typically crystalline and have metal centers coordinated to organic linkers. Metal-organic frameworks have been found useful for gas separation such as gas separation membrane applications.

Energy efficient membrane-based gas separations are attractive alternatives to conventional separation technologies such as distillation. For membrane applications, metal-organic framework materials are in the form of films on porous supports. Polycrystalline metal-organic framework membranes are made by several different methods. Conventional methods include in situ growth and secondary growth. Such conventional methods have various drawbacks such as slow batch processes, which may prevent the commercial applications of these membranes. In addition, drawbacks to such conventional methods include inefficient scalability and reproducibility. Further drawbacks include inefficiencies with the supports and grain boundary defects. In addition, there is no efficient way to heal the defective membranes once membranes are cracked.

Consequently, there is a need for improved synthesis methods for making membranes and films of metal-organic frameworks that address all of the drawbacks described above.

### BRIEF SUMMARY OF SOME OF THE PREFERRED EMBODIMENTS

These and other needs in the art are addressed in one embodiment by a method for producing a metal-organic framework comprising: contacting a porous support with a solution comprising a metal and a solvent; contacting a porous support with a solution comprising a ligand and a solvent; and heating the support for a period of time suitable to substantially evaporate the solution and produce crystals on the surface and the pores.

These and other needs in the art are addressed in one embodiment a method for producing a metal-organic framework comprising: saturating a porous support with a first solution; submerging the saturated porous support in a second solution; sealing the submerged saturated porous support in a heated reactor such that evaporation is not possible; allowing the heated submerged saturated porous support to produce crystals on the surface and the pores of the support.

These and other needs in the art are addressed in one embodiment a method for producing a metal-organic framework, comprising: saturating a porous support with a first solution; submerging the saturated porous support in a second solution; sealing the submerged saturated porous support in a reactor such that evaporation is not possible; exposing the submerged saturated porous support with microwave irradiation to produce crystals on the surface and the pores of the support.

These and other needs in the art are addressed in one embodiment by a rapid thermal deposition method for rapidly depositing functional materials on substrates. In embodiments, the deposition is accomplished by a thermal driving force (i.e., a strong thermal driving force) and a concentration driving force. The materials may be any material fabricated by solution-based self-assembly on a solid surface. In an embodiment, the materials are nanoporous materials.

These and other needs in the art are addressed in another embodiment of a rapid thermal deposition method in which the materials are metal-organic frameworks. The method includes dissolving chemical components of the material in solution. The solution is deposited on the substrate. The substrate is at an elevated temperature. In embodiments, the substrate is held at a high temperature. Without being limited by theory, the thermal driving force induces self-assembly of the components into a thin film of the material of interest on the surface and pores of the support. In embodiments, the rapid thermal deposition method may comprise a catalyst.

These and other needs in the art are addressed in a further embodiment in which the rapid thermal deposition method comprises counter-diffusion. In embodiments, the counter-diffusion method produces metal-organic framework films and membranes. In an embodiment, the counter-diffusion method includes saturating a support with a metal precursor solution. The saturated support is then inserted into a ligand solution and heated to provide a metal-organic framework membrane on the support. In alternative embodiments, the counter-diffusion method includes soaking a support with a ligand solution. After soaking with the ligand solution, embodiments of the counter-diffusion method include soaking the support with a metal precursor solution. In embodiments the ligand and/or metal solution may contain catalysts such as deprotonating agents (e.g., sodium formate).

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

These drawings illustrate certain aspects of some of the embodiments of the present method, and should not be used to limit or define the method.

FIG. 1 illustrates a rapid thermal deposition method in accordance with certain embodiments;

FIG. 2 illustrates a counter-diffusion rapid thermal deposition method in accordance with certain embodiments;

FIG. 3 illustrates a membrane healing counter-diffusion rapid thermal deposition method in accordance with certain embodiments;

FIG. 4 illustrates a microwave seeding rapid thermal deposition method in accordance with certain embodiments;

FIG. 5 illustrates single gas permeances of membranes created by rapid thermal deposition versus membranes created by secondary growth in accordance with certain embodiments.

### DETAILED DESCRIPTION OF THE PREFERRED EMBODIMENTS

In embodiments, a support is contacted with a first solution. In embodiments, the support may be soaked with the first solution. The support may be contacted with the first solution by any suitable method. Without limitation, examples of suitable methods include spray, bath, submersion, slip, drop (i.e., dropping the first solution on the support), spray coating, tape casting, slip coating, and the like. The first solution may include any solution suitable for forming a desired metal-organic framework. In embodiments, the first solution may include a metal and a solvent or a ligand and a solvent. In embodiments, the support is then contacted with a second solution. The support may be contacted with the second solution by any suitable method. Without limitation, examples of suitable methods include spray, bath, submersion, slip, drop (i.e., dropping the first solution on the support), spray coating, tape casting, slip coating, and the like. The second solution may include any solution suitable for forming a desired metal-organic framework. In embodiments, the second solution may include a metal and a solvent or a ligand and a solvent.

In embodiments, the order of the solutions applied is immaterial. The metal and solvent solution may be applied first or the ligand and solvent solution may be applied first. Likewise the solutions may be dissolved in one another (except for counter-diffusion and microwave seeding embodiments which are explained below) before the support contacts either solution such that the support contacts the mixture of the solutions. In embodiments, the construction of the MOFs are dependent on the supports being contacted by both the metal the ligand. Therefore, it is to be understood that unless explicitly stated by an embodiment, the order of solutions applied to the support may be interchanged such the solution order may be reversed or such that the solutions may be combined into a precursor solution before contact with the support.

In embodiments, the metal and solvent solution comprises a metal. Without limitation, examples of suitable metals include copper, zinc, cobalt, aluminum, zirconium, vanadium, chromium, manganese, and the like. The metal may be any suitable metal for the desired metal-organic framework. Metals may be applied in combinations or may be present as a combination in the metal and solvent solution. The metals may be provided by any suitable metal source such as salts, (e.g.; nitrates, chlorides, acetates, etc.). For instance, an example of a suitable copper source is copper nitrate hemi(pentahydrate) and an example of a suitable zinc source is zinc acetate dehydrate. In embodiments the metals may be present in the metal and solvent solution in a range of about 0.01% to about 5%; alternatively about 5% to about 10%; or alternatively about 10% to about 20% by weight of the solution. With the benefit of this disclosure, one having ordinary skill in the art will be able to select a metal for a desired application.

In embodiments, the ligand and solvent solution comprises a ligand. Any suitable ligand may be used. Without limitation, examples of suitable ligands include imidazolates and derivatives such as 2-methylimidazole, carboxylates and derivatives such as 1-4 benzenedicarboxylates, 1,3,5-benzene tricarboxylic acid, and the like. The ligand may be any suitable ligand for the desired ligand-inorganic framework. Ligands may be applied in combinations or may be present as a combination in the ligand and solvent solution. In embodiments the ligands may be present in the ligand and solvent solution in a range of about 0.01% to about 20%; alternatively about 20% to about 40%; or alternatively about 40% to about 60% by weight of the solution. With the benefit of this disclosure, one having ordinary skill in the art will be able to select a ligand for a desired application.

Any suitable solvent may be used. In embodiments, the solvents are any organic solvents suitable for metal-organic synthesis. Without limitation, examples of suitable solvents are alcohols (i.e., methanol, ethanol, and the like), water, dimethylformamide, dimethyl sulfoxide, or any combinations thereof. The choice of solvent is dependent upon the desired application conditions. Solvents may be chosen to control the vapor pressure, evaporation rate, etc. Additionally, solvents may be used in combination to control the vapor pressure, evaporation rate, etc. The solvent may be present in the metal and solvent solution in a range of about 10% to about 50%; alternatively about 50% to about 70%; or alternatively about 70% to about 90% by weight of the solution. The solvent may be present in the ligand and solvent solution in a range of about 10% to about 50%; alternatively about 50% to about 70%; or alternatively about 70% to about 90% by weight of the solution. With the benefit of this disclosure, one having ordinary skill in the art will be able to select a solvent for a desired application.

In some embodiments, a catalyst such as a deprotonator is also dissolved in the metal and/or ligand solutions. Any catalyst suitable for the metal-organic framework may be used. Without limitation, an examples of catalysts are deprotonators such as sodium formate; organic bases such as ethylamine, diethylamine, and the like; inorganic bases such as sodium hydroxide, potassium hydroxide, and the like; as well as combinations thereof. The catalyst may be added to the metal and solvent solution and/or the ligand and solvent solution. Amongst other reasons, the catalyst may be used to increase the reaction rate to insure that a sufficient membrane develops prior to the reactants diffusing or the solvent evaporating. The catalyst may be present in the metal and solvent solution in a range of about 0% to about 10%; alternatively about 10% to about 20%; or alternatively about 20% to about 30% by weight of the solution. The catalyst may be present in the ligand and solvent solution in a range of about 0% to about 10%; alternatively about 10% to about 20%; or alternatively about 20% to about 30% by weight of the solution. With the benefit of this disclosure, one having ordinary skill in the art will be able to select a catalyst for a desired application.

In embodiments the MOF comprises the metal and the ligand from the metal and solvent solution and the ligand and solvent solution. In embodiments the molar ratio of the metal:ligand:catalyst:solvent solution is about 1:X:Y:Z; where the ligand is represented by X and for every 1 mole of metal is present in an amount of about 0.1 mole to about 100 moles; where the catalyst is represented by Y and for every 1 mole of metal is present in an amount of about 0 moles to about 100 moles; and where the combined solvent amount (i.e. the total amount of solvent of both the metal and solvent solution and the ligand and solvent solution) is represented by Z and for every 1 mole of metal is present in an amount of about 10 moles to about 1000 moles. In embodiments the metal:catalyst:solvent solution is about 1:Y:Z; where the catalyst is represented by Y and for every 1 mole of metal is present in an amount of about 0 moles to about 100 moles; and where the solvent is represented by Z and for every 1 mole of metal is present in an amount of about 10 moles to about 1000 moles. In embodiments the ligand:catalyst:solvent solution is about 1:Y:Z; where the catalyst is represented by Y and for every 1 mole of ligand is present in an amount of about 0 moles to about 100 moles; and where the solvent is represented by Z and for every 1 mole of ligand is present in an amount of about 10 moles to about 1000 moles. With the benefit of this disclosure, one having ordinary skill in the art will be able to choose an appropriate molar ratio of components for a desired application.

In embodiments, the support may be any support (i.e., substrate) that is suitable for membrane-based separations. The support need only be porous for it to be suitable. In embodiments, the support may comprise ceramics, polymers, stainless steel, and the like. The support may comprise any shape such as discs, hollow fibers, cylinders, sheets, tubes, tubules, tubulars, and the like. It is to be understood that the shape and materials used for the support are not dependent upon one another, and a support of any shape may comprise any material. With the benefit of this disclosure, one having ordinary skill in the art will be able to select a support for a desired application.

In embodiments the supports comprise pores. The pores may be coated with the first solution of either a ligand or metal before application of the second solution of either a ligand or metal. In embodiments, the pores in the support are sufficiently sized for formation of crystals. In embodiments, the pores are from about 200 nm to about 1 micron, alternatively from about 200 nm to about 500 nm, and alternatively from about 20 nm to about 200 nm. With the benefit of this disclosure, one having ordinary skill in the art will be able to choose a support with a suitable pore size for a desired application.

Embodiments comprise a MOF. The MOF may be a ZIF. Examples of MOF include ZIF-8 (Zeolitic Imidazolate Framework number 8), HKUST-1 (Hong Kong University of Science & Technology number 1), IRMOF-1 (Isoreticular Metal-Organic Framework number 1), MIL-101 (Materials for Institut Lavoisier number 101), U10-66 (University of Oslo number 66), and the like. Any MOF capable of being synthesized on a porous support is suitable for embodiments. With the benefit of this disclosure, one having ordinary skill in the art will be able to construct a MOF membrane for a desired application.

In embodiments the MOF formed may have a crystal size of about 10 nm to about 10 μm. In embodiments the MOF formed may have a thickness of 100 nm to about 50 μm. With the benefit of this disclosure, one having ordinary skill in the art will be able to construct a MOF membrane with the desired crystal size and thickness for a desired application.

In embodiments, the rapid thermal deposition method includes heating the support coated (i.e., saturated) with the first and second solutions. In embodiments, the support may be saturated with the first solution by any such method including spraying, bathing, submerging, slip coating, drop coating (i.e., dropping the first solution on the support), tape casting, and the like. The time taken for saturation of the support in the first solution, may be any time long enough to insure adequate saturation. A factor to consider when selecting the amount of saturation time is the amount of time necessary for the metal or ligand to saturate the pores of the support sufficiently for the MOF to form within the support. The saturated support may be heated by any suitable method such as by autoclave or an oven. In embodiments, the support is heated to any suitable temperature to form crystals and evaporate the solution. In an embodiment, the temperature is less than about 160° C. alternatively between about 60° C. and about 80° C. Embodiments include a temperature between about 10° C. and about 20° C. below the boiling point of the solution. Without being limited by theory, if the temperature is above the boiling point, the result may be a poor quality metal-organic framework film because the solvent may evaporate too quickly. In embodiments, a catalyst may be added to the metal and solvent solution and/or the ligand and solvent solution to mitigate at least part of the effect of increased evaporation rate should the solvent evaporate faster than expected. In embodiments, the solution evaporates from the support and leaves crystals on the support (i.e., on the support surface as well as in the pores of the support). Without limitation, the mechanical properties of the metal-organic framework film are improved with the crystals disposed inside the pores. The rapid thermal deposition method heats the support for a desired time to evaporate the solution (e.g., between about fifteen minutes and about thirty minutes or less) and thereby produces the metal-organic framework films and membranes. The time necessary for evaporation is dependent upon the solvent chosen, etc.

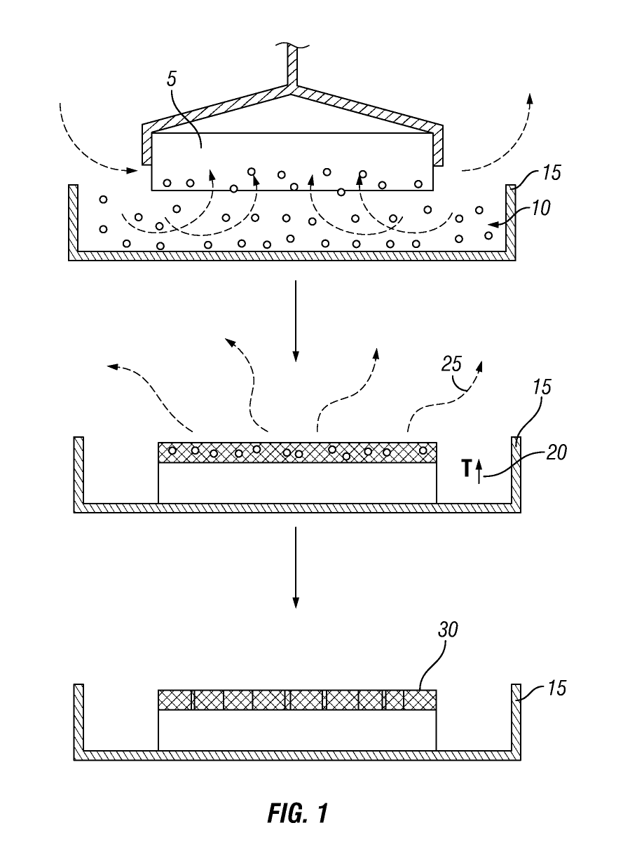

FIG. 1 illustrates a rapid thermal deposition embodiment. In FIG. 1, the metal saturated support 5 is lowered into a ligand and solvent solution 10 within oven 15. As the temperature 20 of oven 15 increases the solvent portion of ligand and solvent solution 10 evaporates as shown by evaporation arrow 25. As the solvent evaporates, an MOF membrane 30 forms that comprises the ligand and the metal from the metal saturated support 5.

In embodiments the rapid thermal deposition method may allow for the repeated application of the metal and solvent solution and the ligand and solvent solution. Repeated treatment with the solutions may be necessary should prior attempts not provide a defect free membrane.

In some embodiments, the rapid thermal deposition method may comprise a counter-diffusion method. In such embodiments, the rapid thermal deposition method includes soaking the support in the metal and solvent solution or the ligand and solvent solution. In embodiments, the support is soaked for a suitable time to fully saturate the pores inside the support with the metal solution. As an example, a support may be soaked in a metal and solvent solution comprising ZnCl₂ dissolved in methanol. In an embodiment, the rapid thermal deposition method (counter-diffusion method) includes solothermally (or hydrothermally) treating the support saturated with the metal solution in a corresponding ligand and solvent or metal and solvent solution to provide crystallization, thereby producing a metal-organic framework membranes formed on the support. In the counter diffusion method the solvent does not evaporate (i.e. evaporation is impossible). Instead the support is sealed in a reactor vessel (e.g. an acid-digestion vessel) under pressure. In the counter diffusion method, a catalyst may be added (amongst other reasons) to increase the reaction rate so as to allow a sufficient membrane to be formed in the reaction zone, prior to the ligand and/or metal diffusing away from the support. The temperature may range from about ambient temperature to about 200° C.

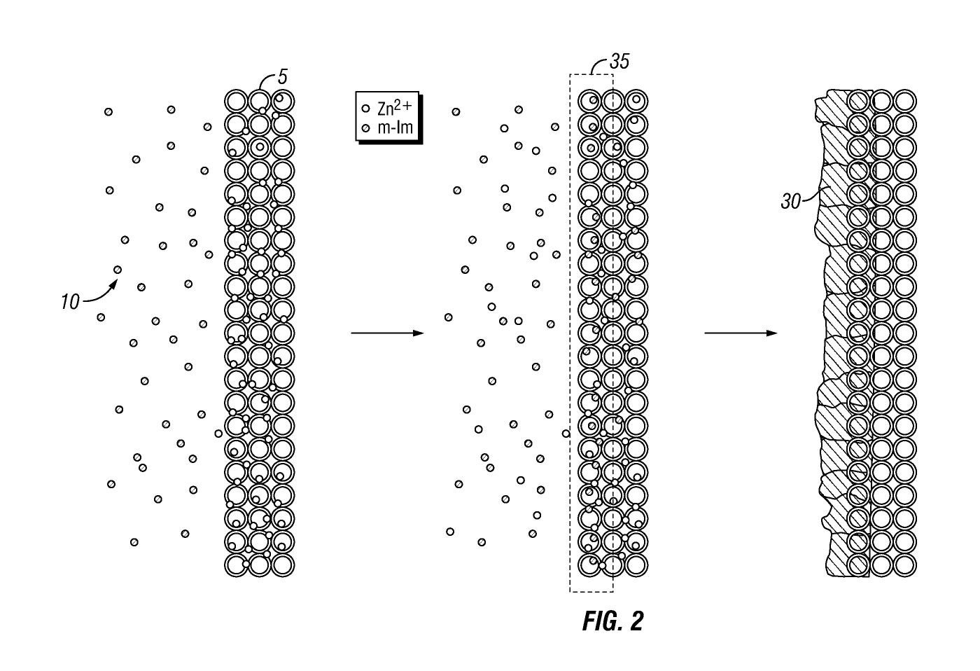

FIG. 2 illustrates a counter-diffusion embodiment. In FIG. 2, the metal saturated support 5 is lowered into a ligand and solvent solution 10. The contra-diffusion reaction starts in the reaction zone 35 of the metal saturated support 5 as the metal diffuses out of the interior of the metal saturated support 5 and the ligand from the ligand and solvent solution 10 diffuses into the metal saturated support 5. An MOF membrane 30 forms in the reaction zone 35 that comprises the ligand and the metal from the metal saturated support 5.

As with non-counter diffusion embodiments, the porous support is able to synthesize crystals within the pores of the support. Unlike non-counter diffusion embodiments, the counter-diffusion method is self-limited since, and without being limited by theory, the metal and ligand complex may only form on the free spaces of the support. This allows for the practical application of a healing method for damaged membranes. Damaged or defective membranes may contain open spaces not covered by a membrane. Within these open spaces, a ligand or metal may be saturated via soaking with a metal and solvent solution or a ligand and solvent solution. Once saturation is completed. The support may be submerged in the corresponding ligand and solvent solution or the metal and solvent solution to undergo the counter-diffusion.

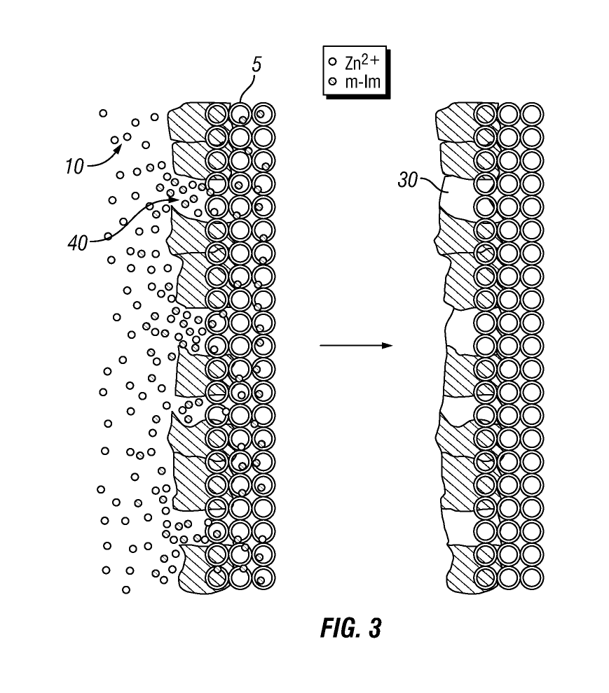

FIG. 3 illustrates a membrane healing counter-diffusion embodiment. In FIG. 3, the metal saturated support 5 is lowered into a ligand and solvent solution 10. As the metal diffuses out of the interior of the metal saturated support 5 and the ligand from the ligand and solvent solution 10 diffuses into the metal saturated support 5 an MOF membrane 30 forms in the defect spaces 40 of the metal saturated support 5.

In an embodiment, microwave irradiation may be used to induce membrane growth and the formation of a seed layer within and on the surface of a porous support. In embodiments, the support that has been saturated with either a metal and solvent solution or a ligand and solvent solution is submerged in the corresponding ligand and solvent solution or the metal and solvent solution is sealed in a container in an oven or a reactor and exposed to microwave irradiation. In this embodiment and similar to the counter diffusion embodiment, the solvent does not evaporate.

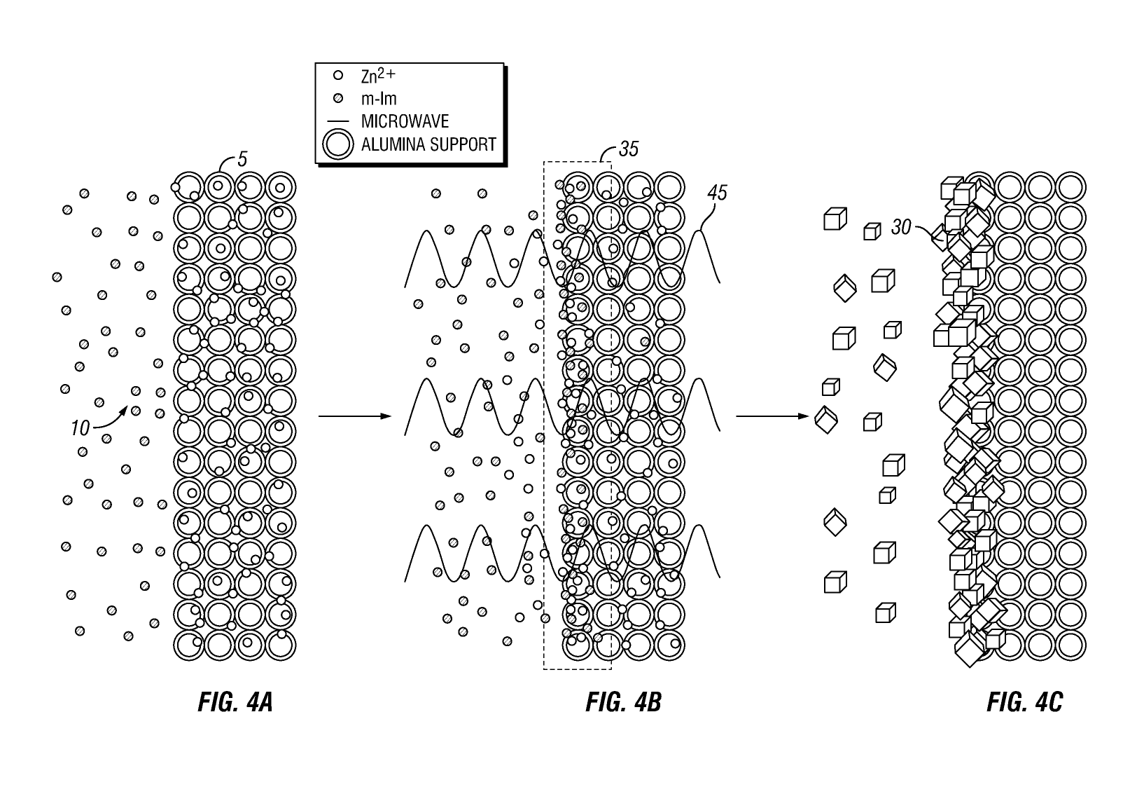

FIG. 4 illustrates a membrane healing counter-diffusion embodiment. In FIG. 4, the metal saturated support 5 is lowered into a ligand and solvent solution 10. Microwave irradiation induces seeding of the membrane within the reaction zone 35 of the metal saturated support 5. An MOF membrane 30 forms in the in the reaction zone 35 of the metal saturated support 5.

In embodiments, since the disclosed methods conserve metal and/or ligand reagents and use less metal and ligand reagents than currently known methods; the metal and solvent solution and/or the ligand and solvent solution may be recycled as the solutions may comprise enough reagent to maintain sufficient reactivity for additional uses. In embodiments, this recycling may comprise reuse of the metal and solvent solution and/or the ligand and solvent solution or it may comprise combining the used metal and solvent solution and/or the ligand and solvent solution with another metal and solvent solution and/or ligand and solvent solution.

In an embodiment, the rapid thermal deposition method provides a rapid deposition of thin films of microporous materials on supports. Without limitation, the rapid thermal deposition method streamlines functional thin film production in a continuous manner. Further, without limitation, the rapid thermal deposition method provides a rapid, scalable fabrication of metal-organic frameworks for membrane-based separations.

Advantages of the rapid thermal deposition method include rapid deposition, rapid crystallization, low chemical consumption, multi-layer deposition, and healing of cracked membranes. In regards to rapid deposition, embodiments include the film deposition taking less than about thirty minutes, alternatively between about fifteen minutes and about thirty minutes, which is much less than the hours or days of conventional techniques. Without limitation, the rapid deposition is accomplished by using a limited volume of solvent and increased temperatures. In embodiments, the amount of solvent may be less than ten (i.e., a few) droplets per cm² of film. In some embodiments, the increased temperatures are relatively high temperatures.

In regards to the advantage of rapid crystallization, such crystallization may occur about concomitantly with film deposition and in some embodiments at about the same time range. Without limitation, the rapid crystallization achieved by using a strong thermal driving force may induce rapid nucleation and growth.

In regards to the advantage of low chemical consumption, rapid thermal deposition may use a relatively small amount of chemical solvents (as compared to conventional hydrothermal fabrication of thin films). The rapid thermal deposition method may achieve such low amounts of chemical solvents by not immersing the support in growth solution to fabricate films. For instance, embodiments of the rapid thermal deposition method include consuming several droplets of synthesis solution per cm² of film, which is in contrast to conventional techniques that may use enough solution to immerse the entire support for film fabrication.

In regards to the advantage of multi-layer deposition, by repeat deposition of growth solution by the rapid thermal deposition method, multi-layer thin films may be fabricated. In embodiments, the rapid thermal deposition method includes controlling film thickness. Embodiments include a film thickness between about 0.1 microns and about 5 microns, alternatively between about 1 micron and about 5 microns, and alternatively less than about 5 microns, and further alternatively less than about 1 micron.

In regards to the advantage of scalable continuous film fabrication, the rapid thermal deposition method provides a film deposition method that may be scaled into a continuous film fabrication process, which is in contrast to conventional techniques that use batch synthesis because of immersion and removal of supports from synthesis solution. Embodiments of the rapid thermal deposition method form thin films in one relatively fast step without any kind of immersion.

In regards to the advantage of healing cracked membranes, the rapid thermal deposition method may further reduce the expense of membranes by healing cracks in membrane modules. Since crystals only grow in the cracks where metal ions and ligand molecules meet, cracked membranes may be rapidly healed. For instance, crystals may be formed at the defect (i.e., crack in the membrane).

In some embodiments, the rapid thermal deposition method allows for the separation of gases such as H₂, CO₂, N₂, CH₄, SF₆, C₃H₆, C₃H₈, and the like by a metal-organic framework.

### EXAMPLES

To facilitate a better understanding of the present embodiments, the following examples of certain aspects of some embodiments are given. In no way should the following examples be read to limit, or define, the scope of the embodiments.

### Example 1

Now a detailed method for the synthesis of HKUST-1 membranes by rapid thermal deposition will be described. A metal solution and a ligand solution were prepared by dissolving 2.5 g of copper nitrate hemi (pentahydrate) [Cu(NO₃)₂*2.5H₂O] and 1.25 g of 1,3,5-benzene tricarboxylic acid (BTC) in 10 mL of DMF, respectively. Both solutions were stirred for 10 minutes. The ligand solution was added to the metal solution dropwise and the mixture was stirred for 10 minutes until a clear solution was obtained. This precursor solution with a molar ratio of Cu:BTC:DMF=1.8:1:43.4 was used for RTD processing. Home-made porous α-alumina disks (porosity=46%, diameter=22 mm, and thickness=2 mm) were used as supports and obtained using a previously reported method. The supports were polished on one side. The supports were slip-coated with the precursor solution (the supports were held horizontally with the polished side facing down, and the precursor solution was brought up in contact with the supports for 30 seconds and then slid away and held vertically). After quickly wicking off the excess precursor solution from the polished side, the slip-coated supports were placed in a preheated oven at 180° C. for 15 minutes with the polished side facing up on a petri dish. After 15 minutes, the oven was turned off and the samples were allowed to cool down naturally to room temperature in the oven. The membranes were then removed, rinsed with methanol, and solvent exchanged for 24 hours in methanol. Membranes were dried under ambient conditions for 12 hours thereafter.

### Example 2

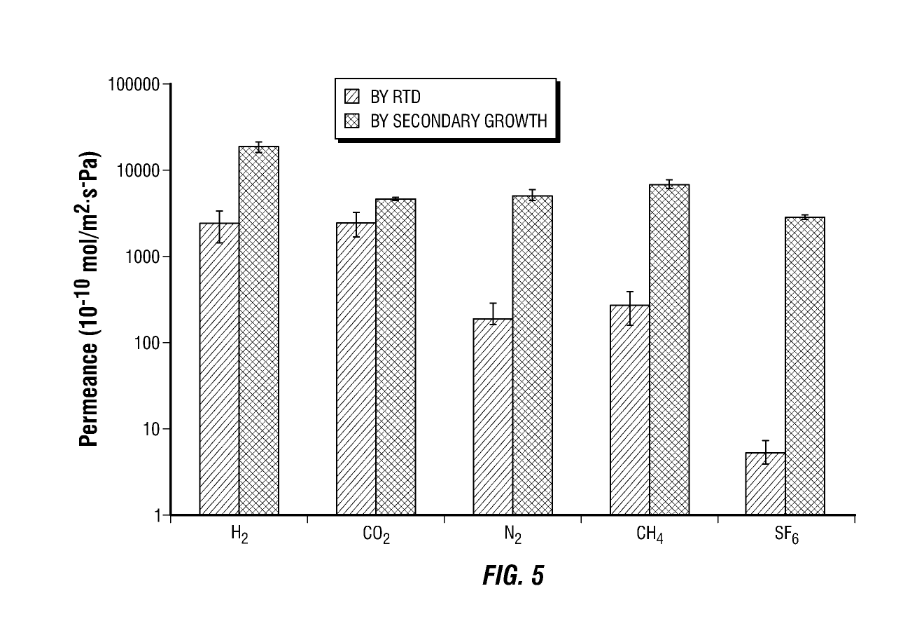

The RTD samples in Example 1 were subjected to single gas permeation measurements versus a control HKUST-1 created by the traditional secondary growth method. Single gas permeation measurements were carried out for gases such as H₂, N₂, CH₄, CO₂, and SF₆, using a time-lag method at room temperature with a feed pressure of 1 bar. Prior to the measurements, as-prepared HKUST-1 membranes were exchanged in methanol for 24 hours and left on a shelf for at least 12 hours prior to gas permeation measurements. Due to its open metal sites, HKUST-1 is hydrophilic (i.e., water molecules can easily coordinate with the open metal sites). To ensure complete removal of the coordinated water molecules, the membranes were placed in the gas permeation cell and flushed with helium on the feed side and vacuum on the permeate side for 24 hours. The results of this test are illustrated in FIG. 5.

The results indicate that the permeances of all gases except CO₂ through the RTD membranes are substantially lower than those through conventional membranes. The lower permeances indicate that the RTD-HKUST-1 membranes have a much better microstructure (i.e., grain boundary structure) given the similar membrane thickness (˜20-25 μm). With better grain boundary structure, nonselective intracrystalline diffusion can be suppressed, resulting in high H₂/SF₆ selectivity.

### Example 3

Now a detailed method for the synthesis of ZIF-8 membranes by rapid thermal deposition will be described. A metal solution and a ligand solution were prepared by dissolving 1.32 g of zinc acetate dihydrate (Zn(OAc)₂*2H₂O) and 1.00 g of 2-methylimidazole (m-lm) in 15 mL solvent, respectively. The solvent used was a mixture of DMA and DI water with the ratio 2:1 (v/v). The ligand solution was added dropwise to the metal salt solution and stirred for 1 min. This precursor solution with a molar ratio of Zn:m-lm:DMA/DI=1:2:128 was immediately used for slip coating on an α-alumina support, in a similar manner as described in Example 1 above. The slip-coated supports were placed in the oven at 200° C. for 15 minutes. After 15 minutes, membranes were slowly cooled down to room temperature, similar to the HKUST-1 membrane. ZIF-8 membranes were rinsed with DMA, followed by ethanol rinsing and solvent exchange in ethanol for 3 days. After solvent exchange, the membranes were dried at 85° C. for 12 hours.

### Example 4

Now a detailed method for the healing of defective ZIF-8 membranes by counter diffusion will be described. Defective membranes were synthesized in a similar manner described above but using recycled precursor solutions. A poorly intergrown ZIF-8 membrane was loaded into a homemade diffusion cell. A ligand solution (2.27 g of 2-methyimidazole in 20 mL of D.I. water) was poured into the support side of the diffusion cell and kept for 1 hour in order to saturate the support. A metal solution (0.11 g of zinc nitrate hexahydrate in 20 mL of D.I. water) was supplied into the membrane side of the diffusion cell. Finally, the diffusion cell was kept in an oven at 30° C. for 6 hours for the healing process. The healed membrane was washed in methanol for 5 days under stirring followed by drying at 60° C. for 6 hours.

Although the present invention and its advantages have been described in detail, it should be understood that various changes, substitutions and alterations may be made herein without departing from the spirit and scope of the invention as defined by the appended claims.

It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present embodiments are well adapted to attain the ends and advantages mentioned as well as those that are inherent therein. The particular embodiments disclosed above are illustrative only, and may be modified and practiced in different but equivalent manners apparent to those skilled in the art having the benefit of the teachings herein. Although individual embodiments are discussed, the invention covers all combinations of all those embodiments. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the invention. If there is any conflict in the usages of a word or term in this specification and one or more patent(s) or other documents that may be incorporated herein by reference, the definitions that are consistent with this specification should be adopted.

What is claimed is:

1. A method for producing a metal-organic framework comprising:
contacting a porous support with a solution comprising a metal and a solvent;
contacting a porous support with a solution comprising a ligand and a second solvent; and
heating the support for a period of time suitable to substantially evaporate the solution and produce crystals on the surface and the pores.

2. The method of claim 1 wherein the metal comprises copper, zinc, cobalt, aluminum, zirconium, vanadium, chromium, manganese, or any combinations thereof.

3. The method of claim 1 wherein the ligand comprises an imidazolate or a benzene carboxylate.

4. The method of claim 1 further comprising a catalyst, wherein the catalyst comprises an amine or an organic base.

5. The method of claim 1 wherein the solvent and/or the second solvent comprises water, an alcohol, dimethylformamide, dimethyl sulfoxide, or any combinations thereof.

6. The method of claim 4 wherein a molar ratio of the metal:ligand:catalyst:solvent is about 1:X:Y:Z; wherein the ligand is represented by X and for every 1 mole of metal is present in an amount of about 0.1 mole to about 100 moles; wherein the catalyst is represented by Y and for every 1 mole of metal is present in an amount of about 0 moles to about 100 moles; and wherein the combined solvent amount of the solvent and the second solvent is represented by Z and for every 1 mole of metal is present in an amount of about 10 moles to about 1000 moles.

7. A method for producing a metal-organic framework comprising:
saturating a porous support with a first solution to produce a saturated porous support;
submerging the saturated porous support in a second solution to produce a submerged saturated porous support;
sealing the submerged saturated porous support in a heated reactor such that evaporation is not possible to produce a heated submerged saturated porous support;
allowing the heated submerged saturated porous support to produce crystals on the surface and the pores of the support.

8. The method of claim 7 wherein the first solution comprises a metal and a solvent and wherein the second solution comprises a ligand and a second solvent.

9. The method of claim 7 wherein the first solution comprises a ligand and a solvent and wherein the second solution comprises a metal and a second solvent.

10. The method of claim 7 wherein the first solution or the second solution comprises a metal comprising copper, zinc, cobalt, aluminum, zirconium, vanadium, chromium, manganese, or any combinations thereof.

11. The method of claim 7 wherein at least one of the first solution or the second solution comprises a ligand comprising an imidazolate or a benzene carboxylate.

12. The method of claim 7 further comprising a catalyst, wherein the catalyst comprises an organic base or an inorganic base.

13. The method of claim 8 wherein the solvent comprises water, an alcohol, dimethylformamide, dimethyl sulfoxide, or any combinations thereof.

14. The method of claim 8 wherein the first solution further comprises a catalyst and wherein the second solution further comprises a catalyst; wherein the molar ratio of the first solution (metal:catalyst:solvent) is about 1:Y:Z; wherein the catalyst is represented by Y and for every 1 mole of metal is present in an amount of about 0 moles to about 100 moles; and wherein the solvent is represented by Z and for every 1 mole of metal is present in an amount of about 10 moles to about 1000 moles; and wherein the molar ratio of the second solution (ligand:catalyst:second solvent) solution is about 1:Y:Z; wherein the catalyst is represented by Y and for every 1 mole of ligand is present in an amount of about 0 moles to about 100 moles; and wherein the second solvent is represented by Z and for every 1 mole of ligand is present in an amount of about 10 moles to about 1000 moles.

15. The method of claim 9 wherein the first solution further comprises a catalyst and wherein the second solution further comprises a catalyst; wherein the molar ratio of the second solution (metal:catalyst:second solvent) is about 1:Y:Z; wherein the catalyst is represented by Y and for every 1 mole of metal is present in an amount of about 0 moles to about 100 moles; and wherein the second solvent is represented by Z and for every 1 mole of metal is present in an amount of about 10 moles to about 1000 moles; and wherein the molar ratio of the first solution (ligand:catalyst:solvent) is about 1:Y:Z; wherein the catalyst is represented by Y and for every 1 mole of ligand is present in an amount of about 0 moles to about 100 moles; and wherein the solvent is represented by Z and for every 1 mole of ligand is present in an amount of about 10 moles to about 1000 moles.

16. A method for producing a metal-organic framework, comprising:
saturating a porous support with a first solution to provide a saturated porous support;
submerging the saturated porous support in a second solution to provide a submerged saturated porous support;
sealing the submerged saturated porous support in a reactor such that evaporation is not possible;
exposing the submerged saturated porous support to microwave irradiation to produce crystals on a surface and pores of the support.

17. The method of claim 16 wherein the first solution and/or the second solution comprises a metal comprising copper, zinc, cobalt, aluminum, zirconium, vanadium, chromium, manganese, or any combinations thereof.

18. The method of claim 16 wherein the first solution and/or the second solution comprises a ligand comprising an imidazolate or a benzene carboxylate.

19. The method of claim 16 wherein the first solution and/or the second solution further comprising a catalyst, wherein the catalyst comprises an amine or an organic base.

20. The method of claim 16 wherein the first solution and/or the second solution further comprises a solvent comprising water, an alcohol, dimethylformamide, dimethyl sulfoxide, or any combinations thereof.
